(19) United States
(12) Patent Application Publication
(10) Pub. No.: US 2023/0295489 A1
(43) Pub. Date: Sep. 21, 2023

(54) A THERMORESPONSIVE SELF-ASSEMBLED ORGANIC MATERIAL AS PHOTONIC INK AND A PROCESS OF MAKING THEREOF

(71) Applicant: COUNCIL OF SCIENTIFIC AND INDUSTRIAL RESEARCH, New Delhi (IN)

(72) Inventors: Ayyappanpillai AJAYAGHOSH, Pappanamcode, Kerala, Thiruvananthapuram (IN); Sandeep CHERUMUKKIL, Pappanamcode, Kerala, Thiruvananthapuram (IN); Vijayakumar CHAKKOOTH, Pappanamcode, Kerala, Thiruvananthapuram (IN)

(21) Appl. No.: 18/004,436

(22) PCT Filed: Sep. 6, 2021
(86) PCT No.: PCT/IN2021/050860

§ 371 Date: Jan. 5, 2023

(30) Foreign Application Priority Data
Sep. 5, 2020 (IN) 202011038507

(51) Int. Cl. C09K 11/06; C09D 11/033; C09D 11/108

(52) U.S. Cl. CPC C09K 11/06; C09D 11/033; C09D 11/108

(57) ABSTRACT

The invention relates to a process for the synthesis of two-dimensionally-layered-structure represented by the general Formula I with improved properties having the advantages of photonic band gap material. The structure of Formula I show enhanced and spectrally controlled/tunable photo-luminescence. Particularly, an ink formulation is created from the annealed powder of the Formula I using a polymer as a binder and organic solvent as a dispersant. wherein, R₁=R₂=R₃=alkyl or alkoxy hydrocarbon X=—CONH or —NH or —COO or —CO or —SO₂NH n=1 or 2 or 3

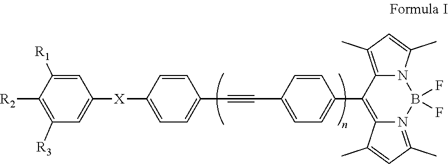

### FIELD OF THE INVENTION

The present invention relates to a thermoresponsive two-dimensionally periodic-layered self-assembly of an organic luminescent chromophore of formula 1 with properties incorporating the advantages of a photonic material [photonic ink].

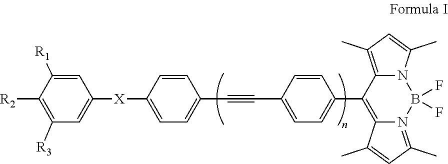

wherein,

R₁, R₂ and R₃₌alkyl [C₁-C₁₈] or alkoxy [C₁-C₁₈] hydrocarbon;

X=—CONH or —NH or —COO or —CO or —SO₂NH;

n=1 or 2 or 3.

Particularly, present invention relates to material that shows enhanced and spectrally controlled/tunable photoluminescence. More particularly, present invention relates to a process for the preparation of fluorescent, thermo-responsive, photonic ink.

### BACKGROUND AND PRIOR ART OF THE INVENTION

Colors are important in life not only for aesthetic reasons but also for communication, signalling, safety and security applications. Colors are usually produced through either the absorption of light by molecules (pigmentary colors) or scattering of light by periodically arranged nanostructures (structural colors). Structural colors are often considered to be superior to pigmentary colors because of their tunability (possible to create any color in the visible spectrum), stability (resistance to light and chemicals), and reduced dependence on expensive/toxic metals/materials. Natural creations such as the shells of marine species, wings of butterflies and the feathers of birds exhibit distinct angle-dependent reflection of light, resulting in brilliant color variations. These are typical examples of photonic functional materials. [See US Patent No. WO2018098232A1, Reference may be made to Eliason, C. M. et al. J. R. Soc. Interface, 2012, 9, 2279-2289, Eliason, C. M., Proc. Biol. Sci. 2013, 280, 20131505 and Shawkey, M. D., J. Morphol. 2015, 276, 378.]

Many recent studies have demonstrated the use of advanced self-assembly techniques to produce photonic materials that generate colors across the visible spectrum. [See US Patent No. US 2002/0062782A1, U.S. Pat. No. 7,106,938B2, WO 2006/084123A2]. Nanoimprint lithography (NIL) is a common method to develop high-performance and low-cost photonic materials. Recently, advanced NIL and soft-lithography techniques are being used for large-scale fabrication of functional photonic materials. For example, roll-to-roll NIL, roll-to-plate NIL, reverse NIL, dip pen NIL techniques are recently being reported. [Reference may be made to Zhang, C. et al. J. Mater. Chem. C, 2016, 4, 5133 and Lova, P. et al. Springer International Publishing Switzerland 2015, Organic and Hybrid Photonic Crystals, DOI 10.1007/978-3-319-16580-6_9].

Also, a variety of organic chromophores based photonic ink materials/formulations are reported in recent years [See US Patent No. WO 2005/068566A1, US 2005/0252411A1]. Molecules with high fluorescence quantum yields such as perylenediimides, naphathalene derivatives, BODIPYs, carbon dots, etc., with interesting optical properties are the most explored chromophores for various optoelectronic applications. Among them, BODIPY is a well-studied functional chromophore having a wide range of applications [See U.S. Pat. Nos. 9,611,281B2, 9,267,949B2, US20130244251A1, WO2012071012A2, See EP2384329A1]. However, no photonic ink formulations are reported with these materials.

Though both bottom-up self-assembly and top-down nanolithography methods have been widely used as discussed above, significant challenges remain to achieve the high contrast color switching and a scalable process for industrial applications of photonic materials. Moreover, recent examples of structural colors lack sufficient color saturation in the absence of absorbing materials such as carbon black, gold nanoparticles, or polymers [Reference may be made to Xiao, Ming et al. Sci Adv. 2017, 3, e1701151 and Meadows, M. G. et al. J. R. Soc. Interface, 2009, 6, S107—S113]. Herein, present invention discloses the preparation of a scalable photonic ink formulation based on a BODIPY [Boron-Dipyrromethene] derivative represented by the Formula I having high contrast color switching for anti-counterfeiting and other applications.

### OBJECTIVES OF THE INVENTION

The main objective of the present invention is to provide a fluorescent-dye-derivative of Formula I.

Another objective of the present invention is to provide a thermo-responsive photonic ink formulation consisting of self-assembled powder of the Formula I for anti-counterfeiting and other practical applications.

Yet another object of the present invention is to provide a process of making photonic ink formulation consisting of self-assembled powder of the Formula I.

### SUMMARY OF THE INVENTION

Accordingly, present invention relates to a fluorescent, thermo-responsive, self-assembled, organic chromophore of formula 1

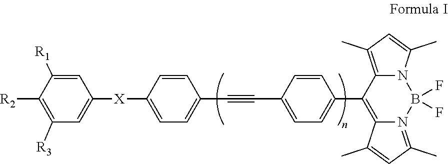

wherein,
R₁, R₂ and R₃=alkyl [C₁-C₁₈] or alkoxy [C₁-C₁₈] hydrocarbon;
X=—CONH or —NH or —COO or —CO or —SO₂NH;
n=1 or 2 or 3.

In an embodiment, present invention provides a photonic ink formulation comprising:
i. an organic chromophore of formula 1 in the range of 10 to 40 wt %;
ii. a polymer binder or resin in the range of 10 to 30 wt %;
iii. an organic solvent as a dispersant in the range of 50 to 80 wt %.

In yet another embodiment of the present invention, said formulation is in gel form, film form or dispersion form.

In yet another embodiment of the present invention, the polymer resin used is selected from the group consiting of a polyether alcohol like polyethylene glycol, polypropylene glycol, polybutylene glycol; polyvinyl resin like polyvinyl alcohol, polyvinyl butyral, polyvinyl pyrrolidone, vinyl pyrrolidone-vinyl acetate copolymers; a polyamine resin-like polyallylamine, polyvinylamine and polyethyleneimine; a polyacrylate resin-like polymethyl acrylate, polyethylene acrylate, polymethyl methacrylate, and polyvinyl methacrylate and an amino resin, an alkyl resin, an epoxy resin, a phenol resin, a polyesterimide resin, a polyamide resin, a polyimide resin, a silicone resin, a phenol resin, a ketone resin, rosin, a rosin-modified resin, a petroleum resin, a cellulose resin, and a natural resin.

In yet another embodiment of the present invention, organic solvent used is selected from the group consisting of organic solvent, water and preferred examples include halogen-based solvents; aprotic polar solvents; alcohols; aromatic solvents; ketone-based solvents; and ether-based solvents.

In yet another embodiment, present invention provides a process for the preparation of photonic ink formulation comprising the steps of:
i. dissolving organic chromophore of formula 1 into polymer resin by heating at temperature in the range of 50-60° C. followed by stirring to obtain a solution;
ii. adding 0.1 wt % of photoinitiator followed by degassing for a period in the range of 10-20 min by purging with argon and subsequently exposed to UV light (365 nm) for a period in the range of 70-80 h to form cross-linked gel;
iii. dissolving the cross linked gel as obtained in step (ii) in an organic solvent followed by drop cast over glass substrates and evaporated the solvent under vacuum at room temperature in the range of 25-30° C. to obtain photonic ink formulation.

In yet another embodiment of the present invention, photoinitiator used is 2,2-dimethoxy-2-phenylacetophenone.

In yet another embodiment of the present invention, the said dilution with organic solvent being done by a factor of 20.

In yet another embodiment, present invention provides a process for developing photonic ink formulation comprising the steps of:
i. adding organic chromophore of formula 1 in a solvent to obtain a solution having concentration above 5 mM, more preferably, 10 mM;
ii. drop-casting the solution as obtained in step (9) followed by annealing at temperature in the range of 290-300° C. allows angle-dependent color variation under visible and UV lights.

In yet another embodiment of the present invention, solvent used is toluene.

### BRIEF DESCRIPTION OF THE FIGS.

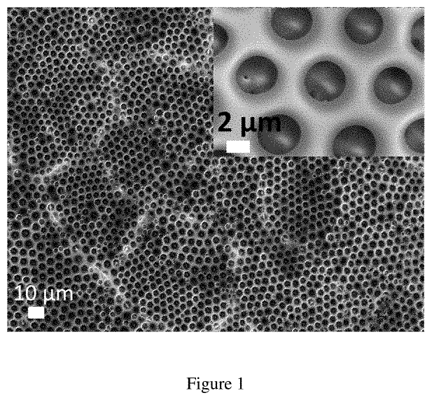

FIG. 1 represents the periodic arrangement of the two-dimensional layered photonic self-assembly obtained by re-dissolving (in chloroform) the polystyrene gel of the annealed photonic material of general Formula I as observed under SEM [Scanning Electron Microscopy] (magnified image is shown in the inset).

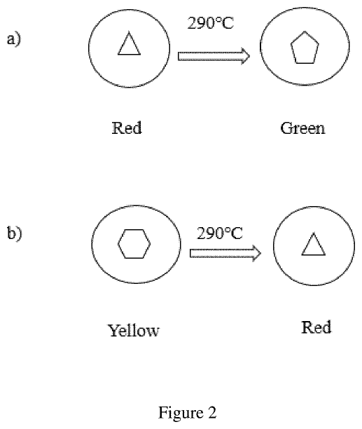

FIG. 2 represents the photographs showing the colors of powder of the general Formula I at room temperature (left) and upon annealing at 290° C. (right) under visible light (2a) and UV light (2b), respectively.

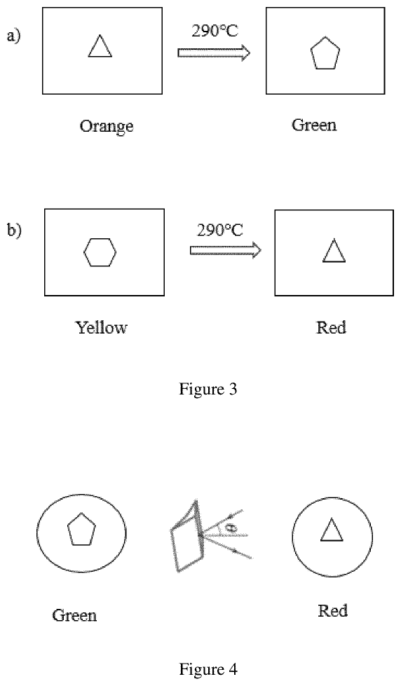

FIG. 3 represents the photographs showing the colors of a film of the general Formula I at room temperature (left) and upon annealing at 290° C. (right) under visible (3a) and UV light (3b), respectively.

FIG. 4 represents the angle-dependent colors of the annealed film of the general Formula I under daylight.

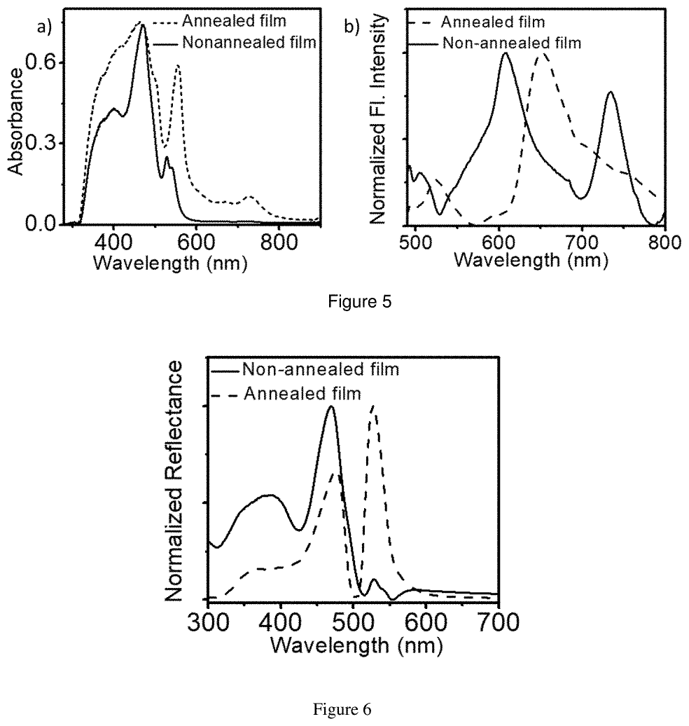

FIG. 5 represents absorption (left) and emission (right; Aex [Lamda excitation], 475 nm) spectra of the film of the general Formula I at room temperature (solid line) and upon annealing at 290° C. (dotted line).

FIG. 6 represents the reflectance spectra of the film of general Formula I at room temperature (solid line) and upon annealing at 290° C. (dotted line).

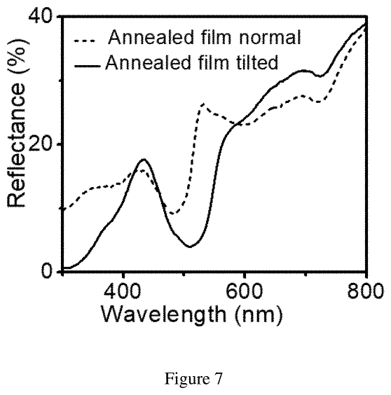

FIG. 7 represents the angle-dependent reflectance spectra of the 290° C. annealed film of general Formula I corresponding to the green (solid line) and red (dotted line) colors as in FIG. 3.

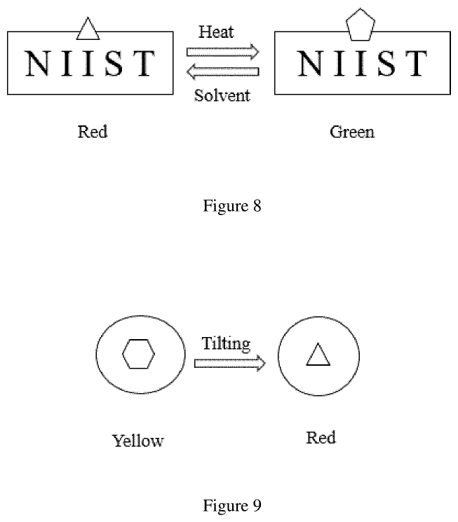

FIG. 8 represents the reversible thermochromic fluorescence response of an ink formulated from an annealed powder of the general Formula I.

FIG. 9 represents the angle-dependent colors of the film obtained by re-dissolving the polystyrene gel of the annealed photonic material of general Formula I in chloroform under daylight.

### DETAIL DESCRIPTION OF THE INVENTION

The invention provides a photonic material which comprises of a two-dimensionally periodic microporous structural matrix of interconnecting, crystallographically oriented, monodispersed members having voids between adjacent members. Present invention provides a method to make photonic structures from the self-assembled material of the general Formula I, which showed angle-dependent color changes and photoluminescence.

Further, the present invention provides a process for the preparation of fluorescent thermo-responsive photonic annealed powder of Formula I for anti-counterfeiting and other practical applications in the form of an ink formulation.

The present invention also provides a process to make a photonic ink formulation consisting of the Formula I. The present invention also provides the use of the fluorescent property of the photonic material as temperature stimuli-responsive ink. The present invention also provides the use of annealed photonic material of the Formula I capable of showing two colors in daylight in the polystyrene gel matrix when viewed orthogonally and at a tilted angle of the drop-casted gel over a glass substrate.

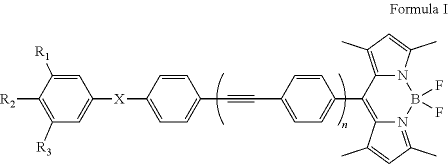

wherein,

R₁=R₂=R₃=alkyl or alkoxy hydrocarbon

X=—CONH or —NH or —COO or —CO or —SO₂NH

n=1 or 2 or 3.

Ri to R₃ stand on each occurrence, identically or differently, for alkyl or alkoxy hydrocarbon. The alkyl group can be straight chain or branched like methyl, ethyl, n-propyl, isopropyl, n-butyl, sec-butyl, tert-butyl, pentyl, hexyl, heptyl, octyl, isooctyl, nonyl, decyl, undecyl, dodecyl, tetradecyl, pentadecyl, hexadecyl, heptadecyl, octadecyl, 2-ethylbutyl, 2,2-dimethylbutyl, n-heptyl, 2-methylhexyl, 3-methylhexyl, 2,2-dimethylpentyl, 3,3-dimethylpentyl, 2,3-dimethylpentyl, 2,4-dimethylpentyl, 3-ethylpentyl, 2,2,3-trimethylbutyl, n-octyl groups. The alkoxy chains can be straight or branched chains like methoxy, ethoxy, n-propoxy, isopropoxy, n-butoxy, sec-butoxy, tert-butoxy, amyloxy, isoamyloxy or tert-amyloxy, heptyloxy, octyloxy, pentoxy, heptyloxy, octyloxy, isooctyloxy, nonyloxy, decyloxy, undecyloxy, dodecyloxy, tetradecyloxy, pentadecyloxy, hexadecyloxy, heptadecyloxy and octadecyloxy groups.

The appended alkyl or alkoxy chains/branches and the functional group of the general Formula I will help the molecule in self-assembling via non-covalent interactions. The fluorescence property of the molecule represented by the general Formula I is introduced by the incorporation of a dye at the end; whereas, the 1,2-diphenylethyne units facilitate controlled aggregation.

‘X’ can be a functional group like secondary amide (—CONH—), amine (—NH), carboxyl (—COO), carbonyl (—CO), and sulphonamide (—NHSO₂—).

The ‘n’ is preferably an integer 1 or 2 or 3. This represents the basic definition.

The fluorescent material is a two-dimensionally periodic layered self-assembly of a dye-represented by the Formula I.

Fluorescent thermo-responsive photonic material is drop-cast from a solution consisting of 10 to 40 weight percent powder of the Formula I, 10 to 30 weight percent of a polymer binder along with 50 to 80 weight percent of an organic solvent as a dispersant, the solvent may be any solvent capable of satisfactorily dissolving or dispersing the components.

The amount of the solvent in the thermo-responsive photonic material by the general Formula I is preferably 50 to 80 weight percentage, more preferably 60 to 80 weight percentage, and further preferably 65 to 70 weight percentage, relative to the total amount of the photonic material of Formula I.

Fluorescent thermo-responsive photonic ink formulation, 10 to 40 weight percent powder of the general Formula I, 10 to 20 weight percent of a polymer binder along with 50 to 80 weight percent of an organic solvent as a dispersant.

The dispersant is capable of satisfactorily dissolving or dispersing or miscible with the components in the mixture. The solvent can be an organic polar solvent and mixed solvents thereof. The dispersant used is selected preferably from an organic solvent, water and preferred examples include halogen-based solvents; aprotic polar solvents; alcohols; aromatic solvents; ketone-based solvents; and ether-based solvents. The dispersant used can be polar protic solvents like water, most alcohols and preferred examples of alcohols such as methanol, ethanol, butanol, isopropanol; aromatic solvents such as chlorobenzene, xylene, benzene, toluene, dichlorobenzene, mesitylene, tetralin, tetramethyl benzene, and pyridine; halogen-based solvents such as chloroform, dichloromethane; aprotic polar solvents such as NMP [N-Methyl-2-pyrrolidone] and DMF

[Dimethylformamide]; and ether-based solvents such as THF, diethylether. The amount of solvent in the preparation of photonic ink may contain solvent up to 50 to 80 by weight percentage, more preferably 60 to 80 by weight percentage, and further preferably 65 to 70 by weight percentage, relative to the total amount of the general Formula I composite material.

A binder in an ink is any substance that allows the dye molecule to adhere to the substrate or printed surface or to allow the dye to uniformly disperse in the ink formulated. The binder used for ink compositions of the present invention is an ingredient not only used for binding the dye by the general Formula I assemblies but also making the ink composition thermally luminescence responsive. Here, it can be a polymer resin that can be dissolved in the above-mentioned solvent satisfactorily and with which the viscosity of the ink composition can be adjusted approximately. Specific examples of the preferred binder resins included the resins listed below: a polyether alcohol like polyethylene glycol, polypropylene glycol, polybutylene glycol; polyvinyl resin like polyvinyl alcohol, polyvinyl butyral, polyvinyl pyrrolidone, vinyl pyrrolidone-vinyl acetate copolymers; a polyamine resin-like polyallylamine, polyvinylamine and polyethyleneimine; a polyacrylate resin-like polymethyl acrylate, polyethylene acrylate, polymethyl methacrylate, and polyvinyl methacrylate and an amino resin, an alkyl resin, an epoxy resin, a phenol resin, a polyesterimide resin, a polyamide resin, a polyimide resin, a silicone resin, a phenol resin, a ketone resin, rosin, a rosin-modified resin, a petroleum resin, a cellulose resin, and a natural resin. It can also be a silicone resin, a phenol resin, a ketone resin, rosin, a rosin-modified resin (phenol, maleic acid, fumaric acid resin, etc.), a petroleum resin, a cellulose resin such as ethyl cellulose and nitrocellulose, and natural resin. Particularly preferred binder resins include polyvinyl resin, polyethylene alcohol, polyacrylate resin, polyamine resin, etc., which are usually employed for photonic inks. Preferably, the polymer resin used is polystyrene, preferably of molecular weight >90000 more preferably >100000.

The combined amount of the binder resin to be blended can be from 10 to 30 by weight percentage, preferably from 10 to 20 by weight percentage based on the total quantity of the ink prepared. If the amount is less than 10 by weight percentage, it is impossible to fix BODIPY compounds on the desired substrate. On the other hand, if the amount is over 30 by weight percentage, the injection stability of the ink compositions may be deteriorated. Further, a binder layer will resultantly cover thickly around a luminous compound, resulting in the probability of deterioration of emission of the luminous compound.

Images or letters are written with photonic ink over paper/alumina substrate initially exhibited two different emission colors, greenish-blue at the edges of the letters and red emission at the core, under a UV lamp. However, upon gradual heating to temperature from 60 to 90° C., more preferably at 80° C., over a hot plate, the luminescence color shifts to yellowish-green. When the substrate was again exposed to solvent vapor, preferably, polar protic solvents, and more preferably, methanol, ethanol, butanol, isopropanol, the initial red luminescence of the general Formula I photonic ink material re-appeared. The luminescence switching is not possible in the absence of a binder.

The photonic material is stable up to 350° C., and is capable of producing a color difference in response to a temperature gradient in the range 250-350° C., preferably in the range of 270-300° C. The photonic material derived from general Formula I also shows color change with respect to angle variation in the range of 0° to 60° preferably 30° to 60°.

### EXAMPLES Following examples are given by way of illustration and therefore should not be construed to limit the scope of the invention.

### Example 1

Preparation of methyl 3,4,5-tris(alkoxy)benzoate (1)

Methyl 3,4,5-trihydroxy benzoate (5 g, 27.2 mmol) and potassium carbonate (18.73 g, 135.8 mmol) were stirred in a 250 ml round bottom flask containing 80 ml dry DMF. The reaction mixture was stirred for 20 minutes under room temperature [25° C.] and added 1-bromoalkane (13.02 g, 95.03 mmol) dropwise. It was then heated to 90° C. for 24 hours. After cooling to room temperature, the reaction mixture was poured into water and extracted the organic part with chloroform repeatedly. Washed the organic layer with enough water and brine solution and dried over anhydrous sodium sulphate. Removed the solvent under reduced pressure and then subjected to purification by column chromatography (silica gel, 1% ethylacetate/n-hexane) to afford compound methyl 3,4,5-tris(alkoxy)benzoate as a white solid.

### Example 2

Preparation of methyl 3,4,5-tris(alkoxy)benzoic Acid (2)

Methyl 3,4,5-tris(alkoxy)benzoate (6 g, 17.03 mmol) was refluxed in ethanol (60 ml) with KOH (3.1 g, 56.2 mmol) in a 250 ml round bottom flask for 12 hours. Cooled back to normal temperature and acidified the reaction mixture with dilute HCl, again cooled in ice-cold water and the precipitate was filtered, washed with water and dried under vacuum to get the pure product methyl 3,4,5-tris(alkoxy)benzoic acid.

### Example 3

Preparation of 3,4,5-tris(alkoxy)-N-(4-iodophenyl)benzamide (3)

The acid 2 (3 g, 8.87 mmol) was dissolved in dry dichloroethane (20 ml) and taken in a 250 ml round bottom flask under argon atmosphere. Thionyl chloride (1.93 ml, 26. 61 mmol) was added dropwise to the reaction chamber and continued stirring for 5 hours. Excess solvent and thionyl chloride was purged out by argon gas and dried completely in vacuum. It was then re-dissolved in 20 ml dry toluene and added to another reaction chamber containing 4-iodoaniline (2.33 g, 10.64 mmol) dissolved in toluene (20 ml) and 2 ml of dry triethyl amine, stirring continued for another 12 hours under argon atmosphere. After completion of the reaction, the solvent toluene was evaporated and residue was extracted using chloroform. The organic layer was washed with water and brine solution and dried over anhydrous sodium sulphate. Purified by silica column chromatography and eluted the compound with 1% ethylacetate/n-hexane solvent system to get the pure product 3 as a white powder.

### Example 4

Preparation of Compound 4

Compound 3 (1 g, 1.9 mmol), bis(triphenylphosphine)palladium (II) dichloride (10 mol %), and copper (I) iodide (10 mol %) were added to an oven-dried two-neck round bottom flask equipped with a magnetic stirring bar. The round bottom flask was then sealed with a rubber septum, evacuated and backfilled with argon three times. Degassed triethylamine (10 ml) was added followed by degas sed THF (20 ml). After stirring for 5 minutes at room temperature, trimethylsilyl acetylene (0.4 ml, 2.8 mmol) was added dropwise into the reaction mixture and continued stirring for 12 hours. The reaction mixture was extracted using chloroform and washed with dilute hydrochloric acid. The organic layer was washed with brine and dried over anhydrous sodium sulphate and then evaporated under reduced pressure. The residue thus obtained purified by silica gel column chromatography using 2% ethylacetate-n-hexane as an eluent.

### Example 5

### Preparation of Compound 5

To a solution of 4 (1 g, 1.96 mmol) in 10 ml dichloromethane, KF (2.23 g, 39.2 mmol) in 50 ml methanol was added to it and allowed to stir at room temperature for 12 hours. After completion of the reaction, the reaction mixture was extracted using chloroform, washed with water, brine and then dried over anhydrous sodium sulphate. The solvent was evaporated under reduced pressure. The residue thus obtained purified by silica gel column chromatography using 5% ethylacetate/n-hexane as an eluent afforded the compound 5 as a white solid.

### Example 6

Preparation of the Formula I

Compound B ODIPY derivative, (4-iodophenyl)-1,3,5,7-tetramethyl-4,4-difluoro-4-bora-3a,4a-diaza-s-indacene) (0.32 g, 0.71 mmol), bis(triphenylphosphine)palladium (II) dichloride (10 mol %), and copper (I) iodide (10 mol %) were added to an oven-dried two-neck round bottom flask equipped with a magnetic stirring bar. The round bottom flask was then sealed with a rubber septum, evacuated and backfilled with argon three times. Degassed triethylamine (30 ml) was added followed by degassed THF (50 ml). After stirring for 5 minutes at room temperature, compound 5 (0.37 g, 0.85 mmol) dissolved in 10 ml (1:1) mixture of degas sed triethylamine and THF was added and the reaction mixture was stirred at 60° C. for 24 hours. The reaction mixture was extracted using chloroform and washed with dilute hydrochloric acid. The organic layer was washed with brine and dried over anhydrous sodium sulphate and then evaporated under reduced pressure. The crude product was then purified by column chromatography using silica gel as adsorbent. The pure compound of the Formula I, 3,4,5-tributoxy-N-(4-((4-(5,5-difluoro-1,3,7,9-tetramethyl-5H-4λ⁴,5λ⁴-dipyrrolo [1,2-c:2′,1′-f][1,3,2] diazaborinin-10-yl)phenyl)ethynyl)phenyl) benzamide was eluted with 40% dichloromethane-n-hexane solvent mixture.

### Example 7

Preparation of SEM Sample

The annealed material of Formula I, 3,4,5-tributoxy-N-(4-((4-(5,5-difluoro-1,3,7,9-tetramethyl-5H-4λ⁴,5λ⁴-dipyrrolo [1,2-c:2′,1′-f][1,3,2]diazaborinin-10-yl)phenyl)ethynyl)phenyl)benzamide-styrene gel diluted with excess chloroform, sonicated, drop-casted over a silicon wafer, which was then subjected to SEM (scanning electron microscope) analysis.

### Example 8

Preparation of Photonic Ink Formulation in Film Form

Self-assembled material of Formula I, 3,4,5-tributoxy-N-(4-((4-(5,5-difluoro-1,3,7,9-tetramethyl-5H-4λ⁴,5λ⁴-dipyrrolo [1,2-c:2′,1′-f][1,3,2]diaz aborinin-10-yl)phenyl)ethynyl)phenyl)benzamide in toluene (5×10-2M) was coated over a glass substrate and subsequently annealed over the hot plate at 290-300° C. inside a glove box.

### Example 9

Preparation of Photonic Ink Formulation in Dispersion Form

Annealed powder (5 mg) of Formula I, 3,4,5-tributoxy-N-(4-((4-(5,5-difluoro-1,3,7,9-tetramethyl-5H-4λ⁴,5λ⁴-dipyrrolo [1,2-c:2′,1′-f][1,3,2]diaz aborinin-10-yl)phenyl)ethynyl)phenyl)benzamide was dispersed in 20 ml of a solution consisting of dispersant (ethanol, 16 g) and binder (poly-ethyleneglycol, 4 g) in the weight ratio of 80:20.

### Example 10

Coating of Substrate Material on Substrates

The above suspension is used to write letters over alumina or filter paper substrate using a brush. The letters initially appeared as red fluorescent and slowly transforms to yellow upon heating to 80° C. slowly over hot plate. The fluorescence is reversed back when the substrate is exposed to solvent vapor (ethanol).

### Example 11

### Preparation of Photonic Ink Formulation in Gel Form

2 mg of Formula I, 3,4,5-tributoxy-N-(4-((4-(5,5-difluoro-1,3,7,9-tetramethyl-5H-4λ⁴,5λ⁴-dipyrrolo[1,2-c:2′,1′-f][1,3,2]diazaborinin-10-yl)phenyl)ethynyl)phenyl)benzamide dissolved in 1 mL of styrene monomer by heating at 50-60° C. followed by stirring. Thereafter, added 0.1 wt % of photoinitiator (2,2-dimethoxy-2-phenylacetophenone) and degassed for 10-20 minutes by purging with argon and subsequently exposed to UV light (365 nm) for 70-80 hours until it forms a cross-linked gel. The average molecular weight of the gel was found to be 100,000 g/mol by GPC [Gel Permeation Chromatograpy] using polystyrene as standard and THF as eluent. The photonic gel film was obtained by dissolving the gel in chloroform, drop cast over glass substrates and evaporated the solvent under vacuum at room temperature (25-30° C.)

### ADVANTAGES OF THE INVENTION

A simple method to make photonic structures from self-assembled organic chromophore of the Formula I, which showed angle-dependent color changes and photoluminescence. The invented photoluminescent photonic material is stable up to 350° C., suitable for real-world applications.
The invented photonic material is capable of exhibiting a high contrast color switching in response to a temperature stimulus.
The invented photonic material exhibits dual-color under daylight when embedded in the polystyrene gel matrix.
These features make this material and ink formulation suitable for anti-counterfeiting and other important applications. Finally, the process developed for the photonic material is scalable one and suitable for industrial-scale production.

1. An organic chromophore of formula I 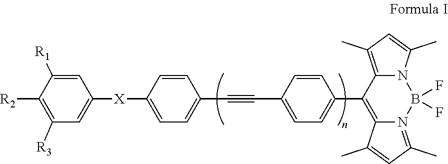
wherein,
R₁, R₂ and R₃=alkyl [C₁-C₁₈] or alkoxy [C₁-C₁₈] hydrocarbon;
X=—CONH or —NH or —COO or —CO or —SO₂NH;
n=1 or 2 or 3.

2. A photonic ink formulation comprising:
i. an organic chromophore of formula I in a range of 10 to 40 wt %, wherein the organic chromophore has a formula 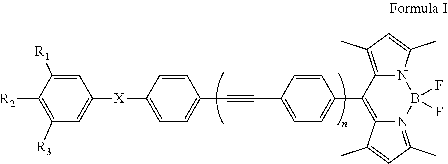
wherein
R₁, R₂ and R₃=alkyl [C₁-C₁₈] or alkoxy [C₁-C₁₈] hydrocarbon;
X=—CONH or —NH or —COO or —CO or —SO₂NH; and
n=1 or 2 or 3;
i. a polymer binder or resin in a range of 10 to 30 wt %;
ii. a solvent as a dispersant in a range of 50 to 80 wt %.

3. The photonic ink formulation as claimed in claim 2, wherein said formulation is in a gel form, a film form or a dispersion form.

4. The photonic ink formulation as claimed in claim 2, wherein the polymer resin is selected from the group consiting of a polyether alcohol; a polyvinyl resin a polyamine resin; a polyacrylate resin an amino resin, an alkyl resin, an epoxy resin, a phenol resin, a polyesterimide resin, a polyamide resin, a polyimide resin, a silicone resin, a phenol resin, a ketone resin, rosin, a rosin-modified resin, a petroleum resin, a cellulose resin, and a natural resin.

5. The photonic ink formulation as claimed in claim 2, wherein solvent is selected from the group consisting of a halogen-based solvent; s aprotic polar solvent; an alcohol-based solvent; an aromatic solvent; a ketone-based solvent; and an ether-based solvent.

6. A process for preparation of a photonic ink formulation as claimed in claim 2, comprising:
i. dissolving organic chromophore of formula 1 into polymer resin by heating at temperature in a range of 50-60° C. followed by stirring to obtain a solution, wherein the organic chromophore has a formula 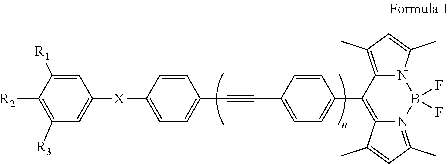
wherein
R₁, R₂ and R₃=alkyl [C₁-C₁₈] or alkoxy [C₁-C₁₈] hydrocarbon;
X=—CONH or —NH or —COO or —CO or —SO₂NH; and
n=1 or 2 or 3;
ii. adding 0.1 wt % of photoinitiator followed by degassing for a period in a range of 10-20 minutes by purging with argon and subsequently exposed to UV light (365 nm) for a period in a range of 70-80 hours to form cross-linked gel;
iii. dissolving the cross linked gel as obtained in step (ii) in an organic solvent followed by drop cast over glass substrates and evaporated the solvent under vacuum at room temperature in a range of 25-30° C. to obtain the photonic ink formulation.

7. The process as claimed in claim 6, wherein the photoinitiator is 2,2-dimethoxy-2-phenylacetophenone.

8. The process as claimed in claim 6, wherein the said dilution with organic solvent is done by a factor of 20.

9. A process for preparing a photonic ink formulation comprising:
i. adding an organic chromophore of formula I in a solvent to obtain a solution having concentration in a range of 5 mM to 10 mM; wherein the organic chromophore has a formula 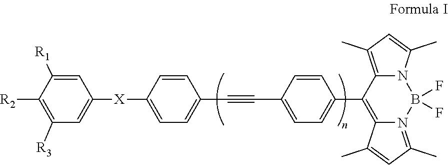
wherein
R₁, R₂ and R₃=alkyl [C₁-C₁₈] or alkoxy [C₁-C₁₈] hydrocarbon,
X=—CONH or —NH or —COO or —CO or —SO₂NH,
n=1 or 2 or 3;
ii. drop-casting the solution as obtained in step ([[9]]i) followed by annealing at temperature in a range of 290-300° C. allows angle-dependent color variation under visible and UV lights.

10. The process as claimed in claim 9, wherein solvent is selected from the group consisting of a halogen-based solvent a protic polar solvent, an aprotic polar solvent an alcohol-based solvent an aromatic solvent a ketone-based solvent and an ether-based solvent.

11. The organic chromophore as claimed in claim 1, wherein the organic chromophore is fluorescent, thermo-responsive and self-assembled.

12. The photonic ink formulation as claimed in claim 4, wherein the polyether alcohol is selected from the group consisting of polyethylene glycol, polypropylene glycol and polybutylene glycol; wherein the polyvinyl resin is selected from the group consisting of polyvinyl alcohol, polyvinyl butyral, polyvinyl pyrrolidone and vinyl pyrrolidone-vinyl acetate copolymers; wherein the polyamine resin is selected from a group consisting of polyallylamine, polyvinylamine and polyethyleneimine; wherein the polyacrylate resin is selected from a group consisting of polymethyl acrylate, polyethylene acrylate, polymethyl methacrylate, and polyvinyl methacrylate; wherein the amino resin is melamine formaldehyde resin; wherein the alkyd resin is polyester resins derived from long chain fatty acid; wherein the epoxy resin is polyepoxide; wherein the phenol resin is phenol formaldehyde; wherein the polyamide resin is nylon based polyamide resin; wherein the polyimide resin is kapton type polyimide resin; wherein the silicone resin is siloxane polymer; wherein the ketone resin is cyclohexanone-aldehyde; wherein the petroleum resin is thermoplastic hydrocarbon; wherein the cellulose resin is cellulose acetate; and wherein the natural resin is selected from the group consisting of rosin and amber.

13. The photonic ink formulation as claimed in claim 5, wherein the halogen-based solvent is selected from the group consisting of chloroform and dichloromethane; wherein the protic polar solvent is selected from the group consisting of water and alcohol-based solvent; wherein the alcohol-based solvent is selected from the group consisting of methanol, ethanol, butanol and isopropanol; wherein the aprotic polar solvent is selected from the group consisting of NMP (N-Methyl-2-pyrrolidone) and DMF (Dimethylformamide); wherein the aromatic solvent is selected from the group consisting of chlorobenzene, xylene, benzene, toluene, dichlorobenzene, mesitylene, tetralin, tetramethyl benzene, and pyridine; wherein the ketone-based solvent is selected from the group consisting of acetone, cyclohexanone, butanone, cyclopentanone; and wherein the ether-based solvent is selected from the group consisting of THF (tetrahydrofuran) and diethylether.

14. The process as claimed in claim 6, wherein the organic solvent is selected from the group consisting of halogen-based solvent; protic polar solvent, aprotic polar solvent; alcohol-based solvent; aromatic solvent; ketone-based solvent; and ether-based solvent.

15. The process as claimed in claim 6, wherein the halogen-based solvent is selected from the group consisting of chloroform and dichloromethane; wherein the protic polar solvent is selected from the group consisting of water and alcohol-based solvent; wherein the alcohol-based solvent is selected from the group consisting of methanol, ethanol, butanol and isopropanol; wherein the aprotic polar solvent is selected from the group consisting of NMP (N-Methyl-2-pyrrolidone) and DMF (Dimethylformamide); wherein the aromatic solvent is selected from the group consisting of chlorobenzene, xylene, benzene, toluene, dichlorobenzene, mesitylene, tetralin, tetramethyl benzene, and pyridine; wherein the ketone-based solvent is selected from the group consisting of acetone, cyclohexanone, butanone, cyclopentanone; and wherein the ether-based solvent is selected from the group consisting of THF (tetrahydrofuran) and diethylether.

16. The process as claimed in claim 6, wherein the halogen-based solvent is selected from the group consisting of chloroform and dichloromethane; wherein the protic polar solvent is selected from the group consisting of water and alcohol-based solvent; wherein the alcohol-based solvent is selected from the group consisting of methanol, ethanol, butanol and isopropanol; wherein the aprotic polar solvent is selected from the group consisting of NMP (N-Methyl-2-pyrrolidone) and DMF (Dimethylformamide); wherein the aromatic solvent is selected from the group consisting of chlorobenzene, xylene, benzene, toluene, dichlorobenzene, mesitylene, tetralin, tetramethyl benzene, and pyridine; wherein the ketone-based solvent is selected from the group consisting of acetone, cyclohexanone, butanone, cyclopentanone and wherein the ether-based solvent is selected from the group consisting of THF (tetrahydrofuran) and diethylether.
